(19) United States
(12) Patent Application Publication
(10) Pub. No.: US 2009/0070187 A1
(43) Pub. Date: Mar. 12, 2009

(54) ENERGY MERCHANT EXCHANGE

(75) Inventor: Andrew S. Webster, Pearland, TX (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/851,757

(22) Filed: Sep. 7, 2007

(51) Int. Cl. G06Q 10/00

(52) U.S. Cl. 705/10; 705/7

(57) ABSTRACT

Methods and systems for evaluating decisions associated with energy market interaction events and providing feedback to users are provided. Market interaction events include events associated with energy production and the sale of energy. Market interaction events that result in lost opportunities are identified and associated lost profits are analyzed and then displayed to users. Policies that result in the lost opportunities may also be identified and changes in policies may be recommended.

### FIELD OF THE INVENTION

This invention relates generally to energy merchants. More particularly, the invention provides methods and systems for evaluating energy market interaction event decisions.

### DESCRIPTION OF RELATED ART

Conventional energy producing enterprises have limited integration between business units that produce energy, through the business units that sell or trade energy. The lack of an effective integrated business model and mechanisms for evaluating decisions can result in inefficient decisions. A business unit that generates energy may make decisions to optimize the amount of energy produced. The decisions made to optimize the amount of energy produced may negatively impact other business units and the enterprise. For example, an energy generation business unit may be tasked with purchasing fuel to produce energy. The business unit may treat buying fuel as procurement function and not as a commercial decision. The price risks associated with fuel prices changing over time may result in the energy generation unit purchasing too much or not enough fuel, which will impact other business units. For example, if not enough fuel is purchased by a generation business unit, a trading business unit will have insufficient energy to sell. Similarly, the trading business unit may make decisions that negatively impact the generation business unit. For example, the trading business unit may set risk guidelines that negatively impact the generation business unit.

The lack of effective mechanisms for evaluating energy market interaction event decisions, such as those relating to production and trading can also result in the inefficient allocation of resources. Decisions may be made to optimize the allocation of resources, such as people and capital, for each business unit instead of the enterprise. For example, a generation business unit may make decisions that result in the business unit acquiring a quantity of fuel at an optimal price for the business unit. The amount of fuel may be more than is necessary to produce the amount of energy that a trading business unit can sell. As a result, resources are allocated to acquire fuel that may not be used because the trading business unit cannot sell the corresponding energy.

Therefore, there is a need in the art for systems and methods for evaluating decisions associated with energy market interaction events.

### BRIEF SUMMARY OF THE INVENTION

Embodiments of the invention overcome problems and limitations of the prior art by providing systems and methods for evaluating decisions associated with energy market interaction events and providing feedback to users. Market interaction events that are associated with the generation and sale of energy are analyzed to identify lost opportunities. Market interaction events may include energy generation events and marketing events. Marketing events may include lost opportunities associated with pricing, unused capacity allocation events and generation allocation events. In some embodiments policies that contribute to the occurrence of market interaction events that result in lost opportunities may be identified and changes in policies may be recommended.

Some embodiments of the invention may be implemented with computer devices and include or utilize computer-executable instructions for performing one or more of the disclosed methods. The computer-executable instructions may be stored on a tangible computer-readable medium, such as a portable memory drive or CD-ROM.

### BRIEF DESCRIPTION OF THE DRAWINGS

The present invention is illustrated by way of example and not limited in the accompanying figures in which like reference numerals indicate similar elements and in which:

FIG. 1 shows a typical prior art workstation and communication connections.

FIG. 2 illustrates an operating model of an integrated energy merchant value chain in accordance with an embodiment of the invention.

FIG. 3 illustrates exemplary functions performed by core value creation functions, integration functions, governance functions and shared services in accordance with an embodiment of the invention.

FIG. 4 illustrates the exchange of information between a generation function and other functions, in accordance with an embodiment of the invention.

FIG. 5 illustrates the exchange of information between a trading function and other functions, in accordance with an embodiment of the invention.

FIG. 6 illustrates the exchange of information between an asset development and management function and other functions, in accordance with an embodiment of the invention.

FIG. 7 illustrates the exchange of information between an asset optimization function and other functions, in accordance with an embodiment of the invention.

FIG. 8 illustrates the exchange of information between a pricing and structuring function and other functions, in accordance with an embodiment of the invention.

FIG. 9 illustrates a method of evaluating decisions associated with energy market interaction events, in accordance with an embodiment of the invention.

FIG. 10 illustrates a graphical user interface that lists lost revenue associated with market interaction events, in accordance with an embodiment of the invention.

FIG. 11 illustrates an exemplary graphical user interface that shows outage trend information, in accordance with an embodiment of the invention.

### DETAILED DESCRIPTION

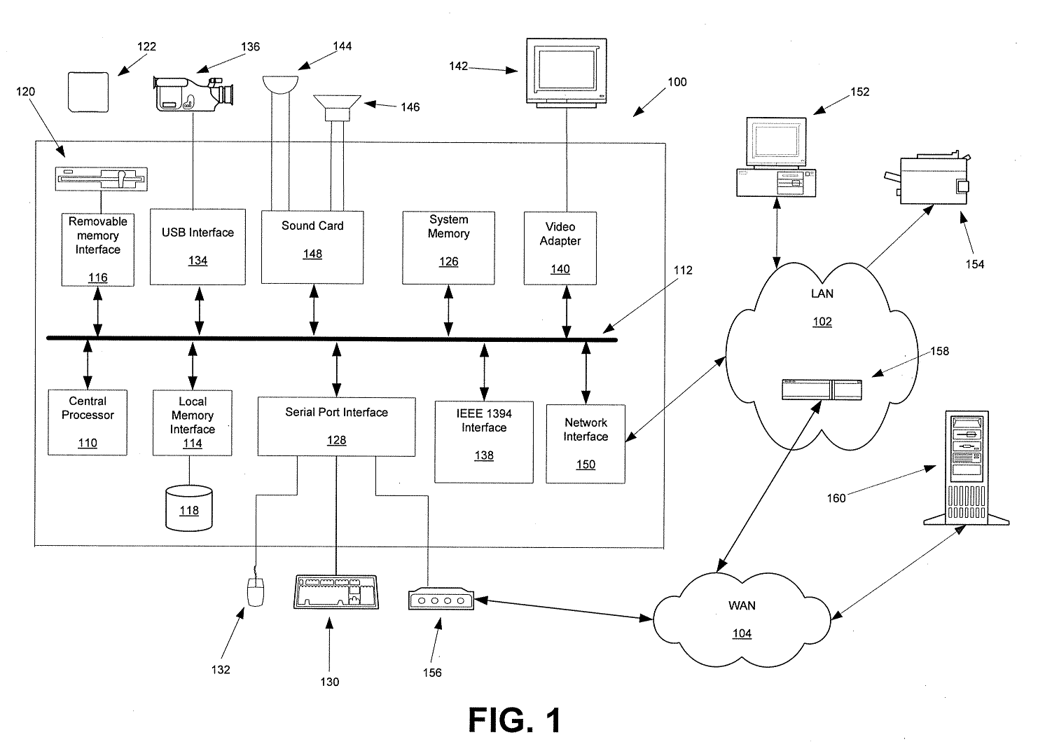

Various embodiments of the present invention may be implemented with computer devices and systems that exchange and process data. Elements of an exemplary computer system are illustrated in FIG. 1, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user can interact with computer 100 with a variety of input devices. FIG. 1 shows a serial port interface 128 coupling a keyboard 130 and a pointing device 132 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a universal serial bus (USB) interface 134 coupling a video or digital camera 136 to system bus 112. An IEEE 1394 interface 138 may be used to couple additional devices to computer 100. Furthermore, interface 138 may configured to operate with particular manufacture interfaces such as FireWire developed by Apple Computer and i.Link developed by Sony. Peripheral devices may include touch sensitive screens, game pads scanners, printers, and other input and output devices and may be coupled to system bus 112 through parallel ports, game ports, PCI boards or any other interface used to couple peripheral devices to a computer.

Computer 100 also includes a video adapter 140 coupling a display device 142 to system bus 112. Display device 142 may include a cathode ray tube (CRT), liquid crystal display (LCD), field emission display (FED), plasma display or any other device that produces an image that is viewable by the user. Sound can be recorded and reproduced with a microphone 144 and a speaker 146. A sound card 148 may be used to couple microphone 144 and speaker 146 to system bus 112.

One skilled in the art will appreciate that the device connections shown in FIG. 1 are for illustration purposes only and that several of the peripheral devices could be coupled to system bus 112 via alternative interfaces. For example, video camera 136 could be connected to IEEE 1394 interface 138 and pointing device 132 could be connected to USB interface 134.

Computer 100 includes a network interface 150 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 152 and printer 154. Computers and other devices may be connected to LAN 102 via twisted pair wires, coaxial cable, fiber optics or other media. Alternatively, radio waves may be used to connect one or more computers or devices to LAN 102.

A wide area network 104, such as the Internet, can also be accessed by computer 100. FIG. 1 shows a modem unit 156 connected to serial port interface 128 and to WAN 104. Modem unit 156 may be located within or external to computer 100 and may be any type of conventional modem, such as a cable modem or a satellite modem. LAN 102 may also be used to connect to WAN 104. FIG. 1 shows a router 158 that may connect LAN 102 to WAN 104 in a conventional manner. A server 160 is shown connected to WAN 104. Of course, numerous additional servers, computers, handheld devices, personal digital assistants, telephones and other devices may also be connected to WAN 104.

The operation of computer 100 and server 160 can be controlled by computer-executable instructions stored on a computer-readable medium. For example, computer 100 may include computer-executable instructions for transmitting information to server 160, receiving information from server 160 and displaying the received information on display device 142. Furthermore, server 160 may include computer-executable instructions for transmitting hypertext markup language (HTML) or extensible markup language (XML) computer code to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102, 104, but also a “content network,” which is comprised of the data—attributable to a single entity—which resides across all physical networks.

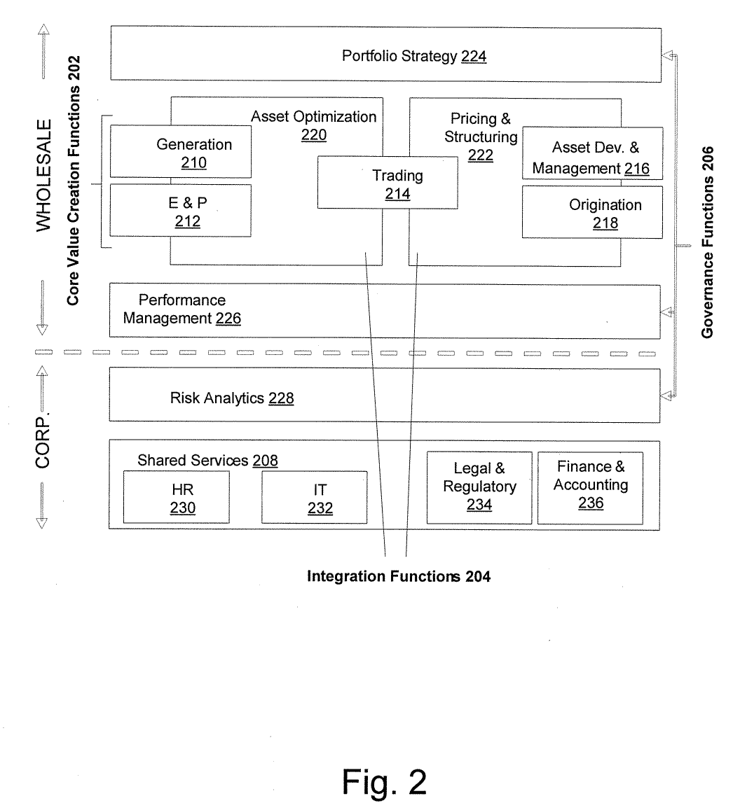

FIG. 2 illustrates an operating model 200 of an integrated energy merchant value chain in accordance with an embodiment of the invention. Operating model 200 is divided into core value creation functions 202, integration functions 204, governance functions 206 and shared services 208. Core value creation functions are those that are primary profit and loss drivers and are generally market facing entities. In the example shown, core value creation functions include power generation 210, E&P 212, trading 214, asset development and management 216 and origination 218. Power generation function 210 may be responsible for maximizing production margin. Production margin may be defined by the internal measurements that balance long and short term value while ensuring environmental compliance and safety. E&P function 212 may be tasked with coordinating coal supply needs with an asset optimization function 220 and power generation function 210 to maximize production margin and balance long and short term value while ensuring environmental compliance and safety. Trading function 214 may executes transactions to optimize the intermediate and short term portfolio within corporate risk tolerances. The transactions may involve the sale and/or purchase of electrical power. Asset development and management function 216 may develop and market projects and contracts to maximize long term profits. And, origination function 218 may be tasked with developing and marketing integrated, comprehensive risk mitigation solutions to optimize premium margin capture.

Integration functions 204 may be tasked with clearly defining interfaces consistent with how value is created in the marketplace and increasing integration, efficiencies, and standardization. Integration functions 204 may also optimize value for a utility or other entity above individual functional value. In the example shown in FIG. 2, integration functions 204 include asset optimization function 220 and pricing & structuring function 222. Asset optimization function 220 integrates production functions (power generation 210 and E&P 212) and trading function 214 to optimize the economic management of production assets and load obligations. Pricing & structuring function 222 supports origination function 218 to create and evaluate deals to achieve the risk and return objectives of a business unit or other entity.

Governance functions 206 may be tasked with centralizing strategic planning and resource allocation, enabling streamlined information flows to and from management entities, enhancing risk analysis capability around business activities improving transparency of risk based decisions within the business unit and with a risk management function. Governance functions 206 may also improve alignment of activities with strategic, financial and risk objectives. Governance functions 206 may include a portfolio strategy function 224, a performance management function 226 and a risk measurement and control function 228. Portfolio strategy function 224 may define overall portfolio strategy, align investments and allocate financial and risk capital to both new and existing business activities. Risk analytics function 228 may create a consolidated view of risk exposure across the enterprise and provides front office analytical support to maximize risk adjusted returns. Performance management function 226 may drive the monitoring and reporting of the overall performance against targets and plans.

Shared services 208 include functions that are shared by core value creation functions 202, integration functions 204 and governance functions 206. Shared services may include human resources 230, information technology 232, legal & regulatory 234 and finance & accounting 236.

Integration of business units within the value chain of an energy merchant and the efficient allocation of resources may be obtained by defining roles that will be performed by each of the core value creation functions 202, integration functions 204 and governance functions 206. Defining roles that will not be performed independently by the core value creation functions 202, integration functions 204 and governance functions 206 also facilitates integration and the efficient allocation of resources.

In one embodiment of the invention, power generation function 210 is tasked with: fulfilling environmental requirements, initiating investment decisions, operating generation plants, maintaining generation plants, managing non-fuel supply chains, optimizing plant performance, responding to dispatch instructions and managing production partners. Power generation function 210 will not independently: assume price risk, make asset investments, make dispatch decisions, acquire assets or divest assets.

Trading function 214 is tasked with: developing short-term tactical trading plans, developing long-term trading plans, developing market viewpoints, executing trading strategies, developing trading hedge strategies for originated positions and assets, executing trading hedge strategies, generating dispatch instructions, interact with portfolio strategy function 224 and executing fuel contracts. Trading function 214 will not independently: make short term dispatch decisions, set risk guidelines, acquire or divest assets or determine dispatch instructions. Trading function 214 may also be responsible for interacting with counterparties, but not customers. Trading function 214 will participate in marketing events. Marketing events include over-the-counter transaction events and structured contract trading events.

Origination function 218 is tasked with: developing marketing strategies and plans, originating load, supply and services, managing deals, measuring origination performance, managing origination customers and originating long-term fuel contracts. Origination function 218 will not independently: acquire or divest assets, enter new markets, regions or customer segments or make final pricing decisions.

E & P function 212 is tasked with: fulfilling environmental and safety requirements, optimizing on-site coal mining activities, initiating investment and expense requests, maintaining mining equipment, responding to mining instructions and managing mining partners and contractors. E & P will not independently: assume price risk, procure fuels, make asset investments, make dispatch decisions, acquire assets or divest assets.

Asset development and management function 216 is tasked with: developing asset development strategies and plans and managing engineering, procurement and development processes. Asset development and management function 216 will not independently: acquire assets, divest assets, enter new markets, enter new regions, enter new customer segments or make final pricing decisions.

Asset optimization function 220 is tasked with: managing environmental positions, developing asset production plans, developing forecasts, developing short-term production plans, managing fuel, dispatching and monitoring production, optimizing commercial operations, optimizing maintenance plans and shedding market price risk to trading. Asset optimization function 220 will not independently: acquire assets, divest assets, make investment decisions, schedule outages, schedule maintenance or make dispatch decisions.

Pricing & structuring function 222 is tasked with: optimizing models, conducting analyses, developing contract forecasts, developing standard products, pricing commodities, structuring deals, evaluating structuring options, incorporating standards, limits and requirements from risk analytics function 228, incorporating standards, limits and requirements from finance related organizations and identifying opportunities to optimize credit exposures. Pricing & structuring function 222 will not independently: determine final pricing for transactions or acquire, sell, or trade gas or power. Pricing & structuring function 222 may also be prohibited from interacting on behalf of one business unit or organizational area. For example, pricing & structuring function 222 could not act on behalf of trading function 214 in a dispute between trading function 214 and origination function 218.

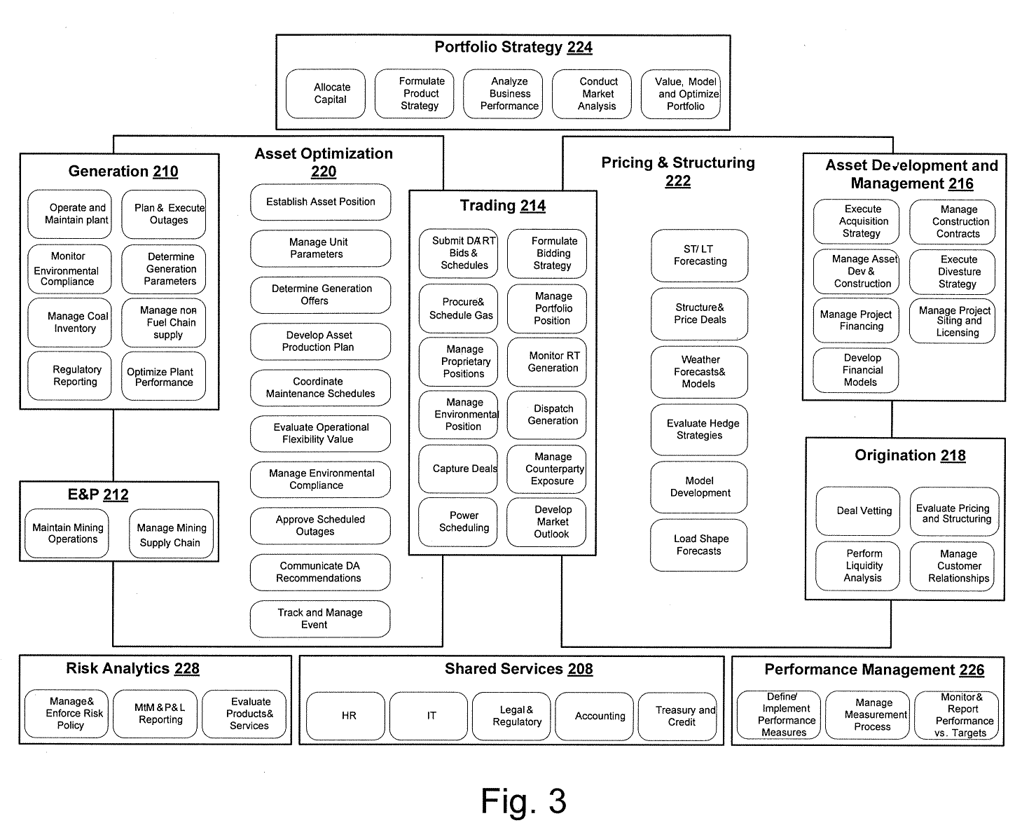

FIG. 3 illustrates exemplary functions performed by core value creation functions, integration functions, governance functions and shared services in accordance with an embodiment of the invention. One skilled in the art will appreciate that the functions shown are exemplary and that additional and/or alternative functions may also be included.

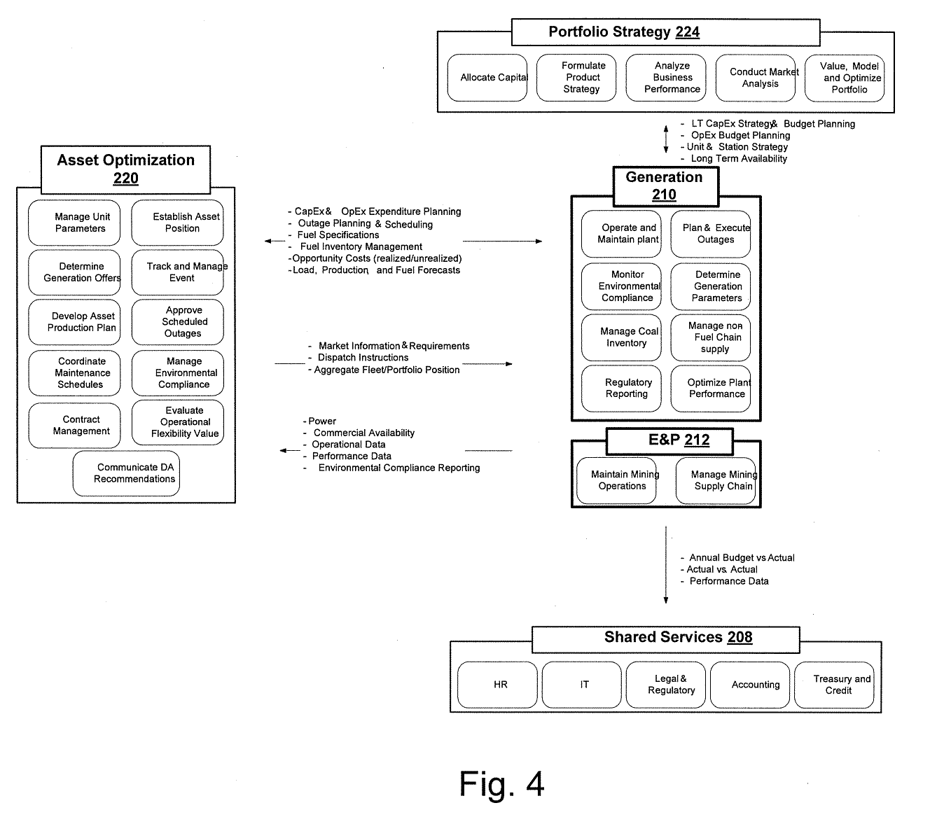

FIG. 4 illustrates the exchange of information between generation function 210 and other functions, in accordance with an embodiment of the invention. Generation function 210 and E&P function 212 provide information such as plant availability, potential operational risk and dispatch instructions. Generation function 210 and E&P function 212 may initiate asset investment opportunities within the existing production portfolio and provide availability data to asset optimization function 220. Generation function 210 and asset optimization function 220 and also develop outage schedules, capital expenditures, and operation and maintenance requirements. Generation function 210 and E&P function 212 will execute production plans and operating instructions and operate plants in accordance with environmental and safety requirements.

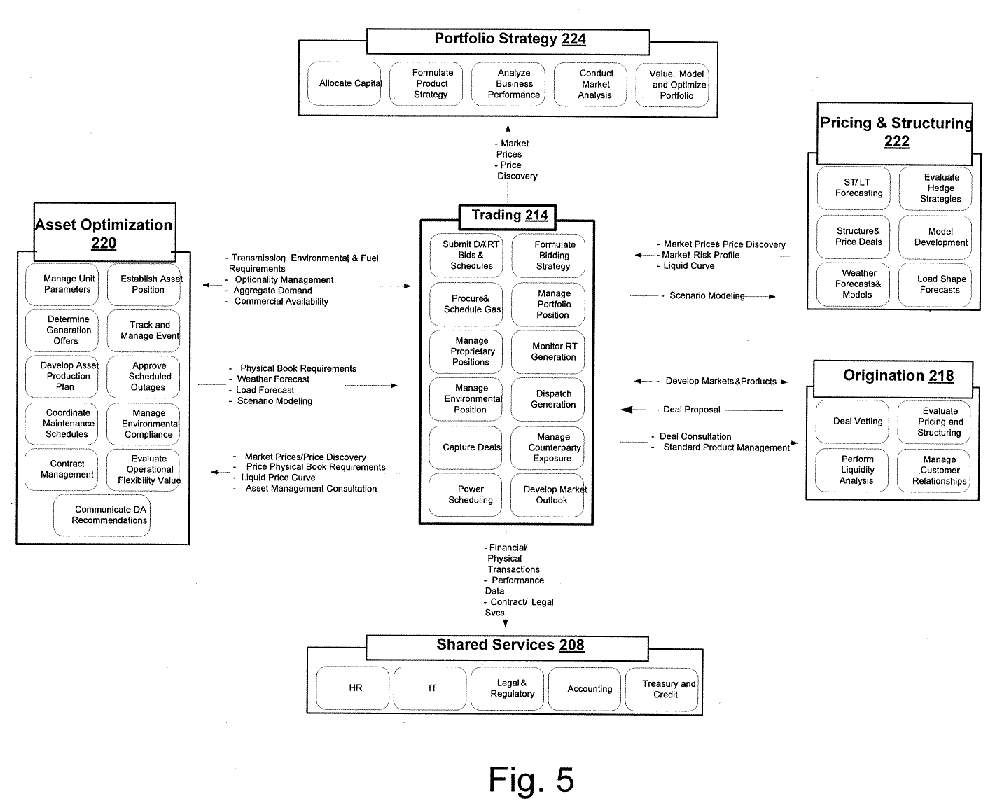

FIG. 5 illustrates the exchange of information between trading function 214 and other functions, in accordance with an embodiment of the invention. Trading function 214 exchanges information involving positions, market data and forecasts. Trading function 214 manages financial books and price risk and obtains risk capital from the enterprise to effectively assume and manage price risk exposures. Trading function 214 creates and exchanges information with portfolio strategy function 224 relating to strategic goals. Trading function 214 may also develop optimization strategies based on risk information received from pricing and structuring function 222.

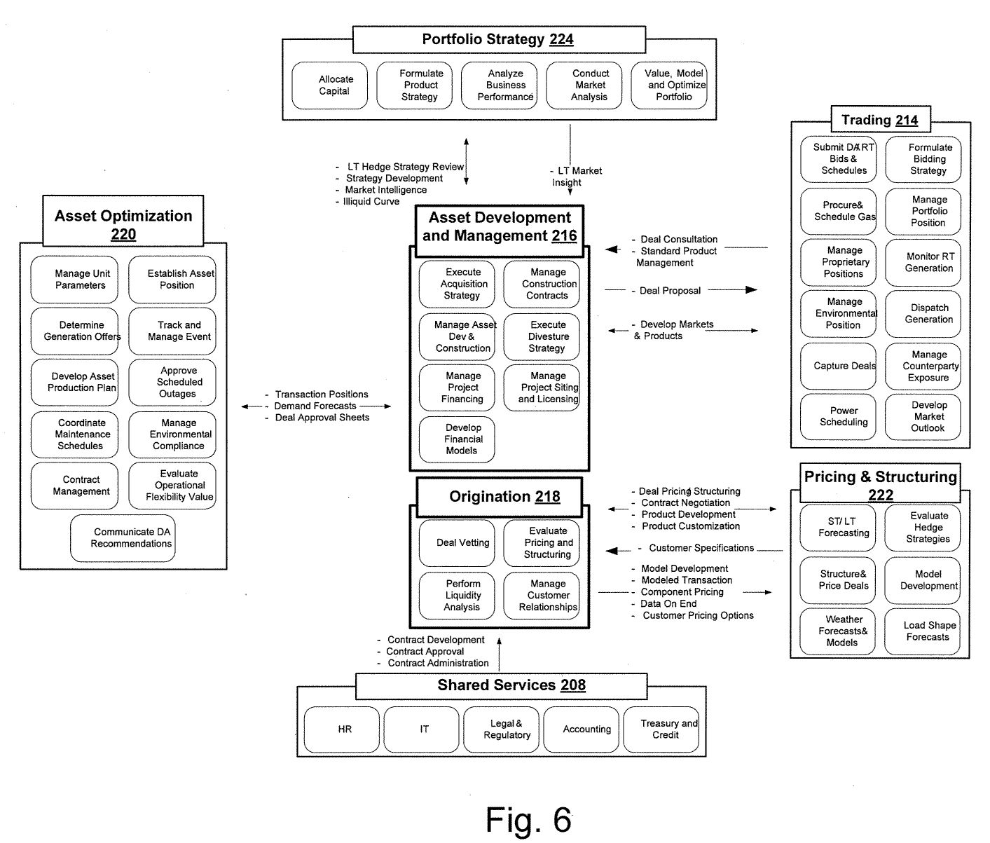

FIG. 6 illustrates the exchange of information between asset development and management function 216 and other functions, in accordance with an embodiment of the invention. Asset development and management function 216 exchanges information relating to equity amounts and resource commitments. Asset development and management function 216 also exchanges information to align market planning with strategic plans provided by portfolio strategy function 224. Origination function 218 receives information regarding contracts from shared services function 208 and exchanges model information with price and structuring function 222.

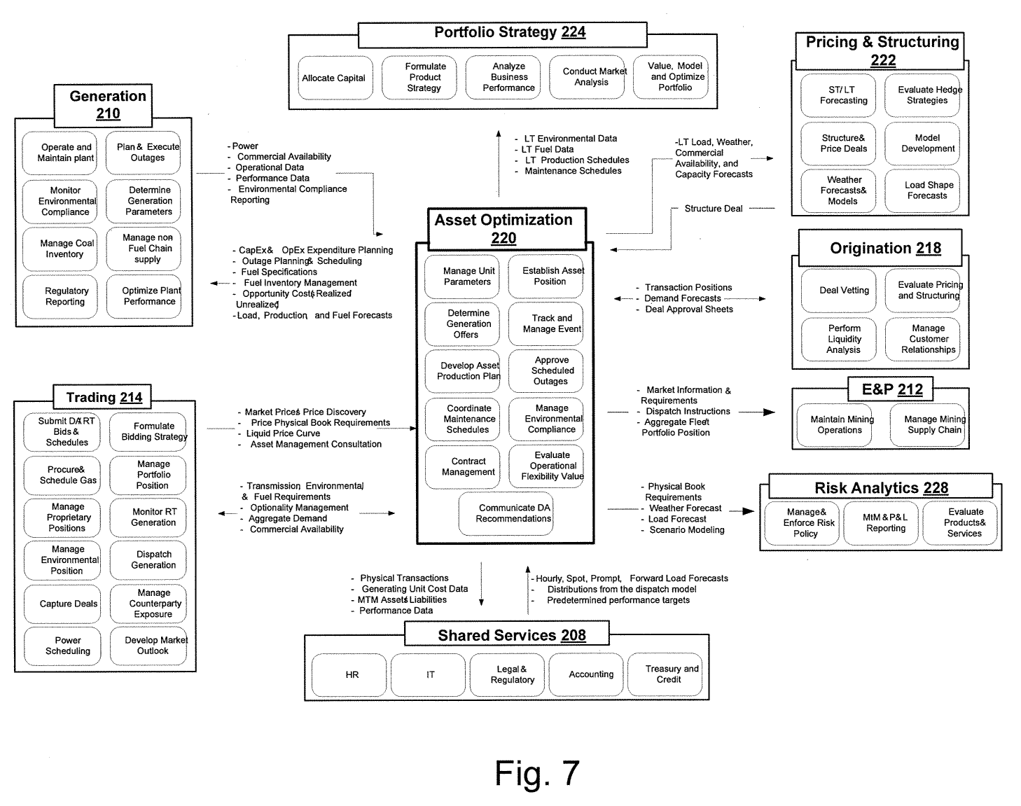

FIG. 7 illustrates the exchange of information between asset optimization function 220 and other functions, in accordance with an embodiment of the invention. Asset optimization function 220 exchanges information with generation function 210 and trading function 214 such that generation function 210 is viewed as a supplier and trading function 214 is viewed as a customer. Asset optimization function 220 also provides forecast data to risk analytics function 228 and pricing and structuring function 222. Transaction positions, demand forecasting and deal approval sheets are exchanged with origination function 218.

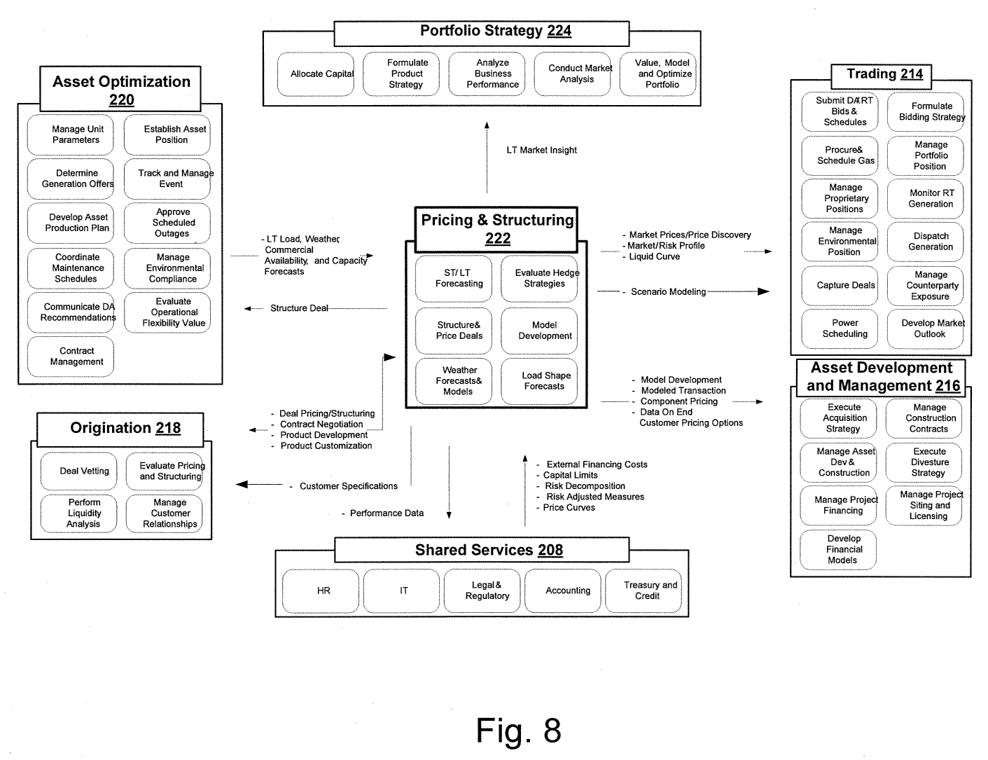

FIG. 8 illustrates the exchange of information between pricing and structuring function 222 and other functions, in accordance with an embodiment of the invention. Pricing and structuring function 222 interacts with origination function 218, trading function 214, and portfolio strategy function 224 to create and value transactions. Pricing and structuring function 222 also provides risk related information and analysis to other functions. The information flow shown in FIG. 8 is structured such that pricing and structuring function 222 is allowed to objectively and fairly represent both internal sides of a transaction.

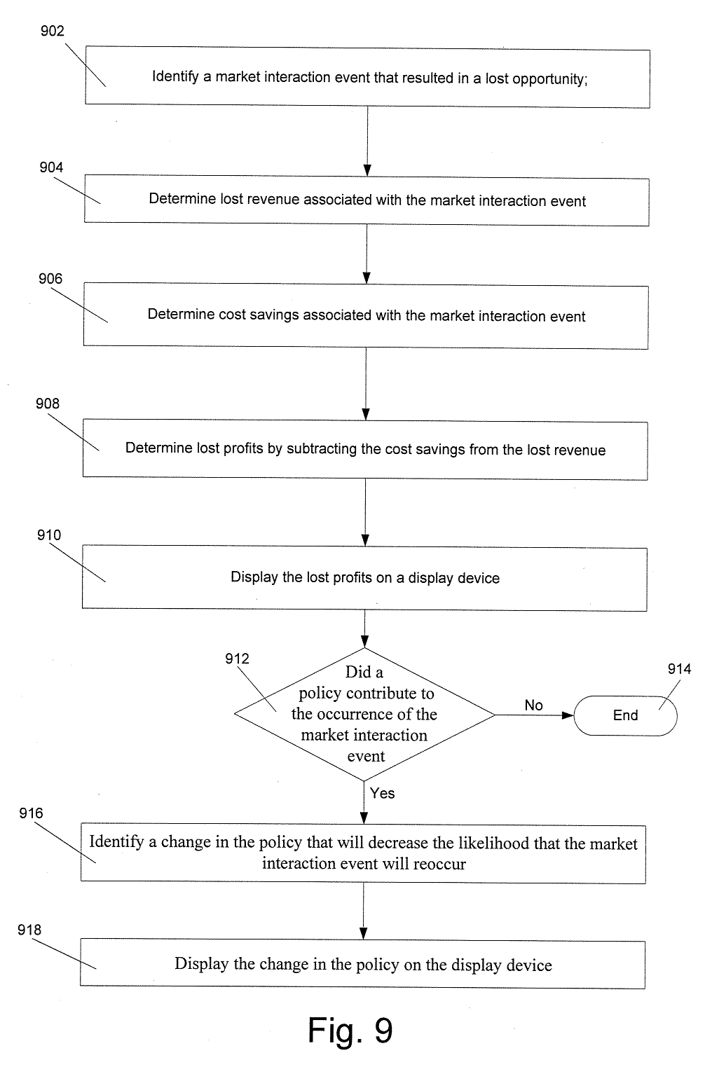

FIG. 9 illustrates a method of evaluating decisions associated with energy market interaction events, in accordance with an embodiment of the invention. First, in step 902, a market interaction event that resulted in a lost opportunity is identified. The market interaction event may be an energy production event or a marketing event. Energy production events may include generation scheduled outage events, generation forced outage events or other events associated with the generation of energy. Marketing events may include lost opportunities associated with pricing, unused capacity allocation events, generation allocation events or other events associate with the sale of energy. In some embodiments marketing events include over-the-counter transaction events and structured contract trading events.

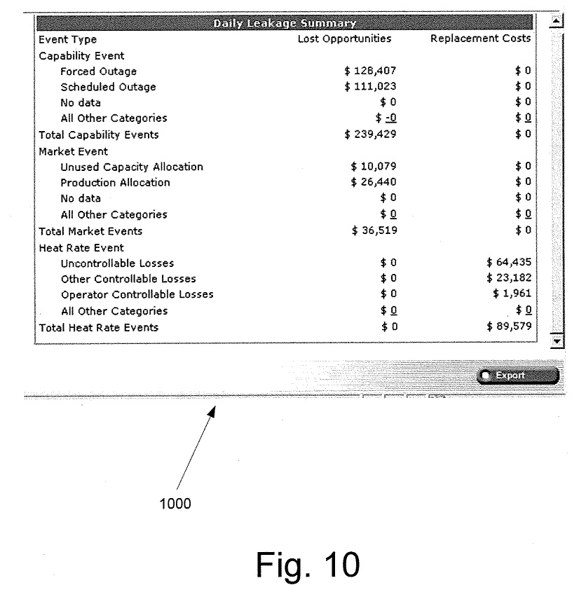

Lost revenue associated with the market interaction event is determined in step 904. For example, lost sales associated with a generation scheduled outage or a missed opportunity associated with trading energy at a price below a market price may be determined. FIG. 10 illustrates a graphical user interface 1000 that lists lost revenue associated with market interaction events. In step 906 any cost savings associated with the market interaction event are determined. An exemplary cost savings may include fuel cost savings that occur during a generation scheduled outage. Next, lost profits are determined by subtracting any cost savings from lost revenue in step 908.

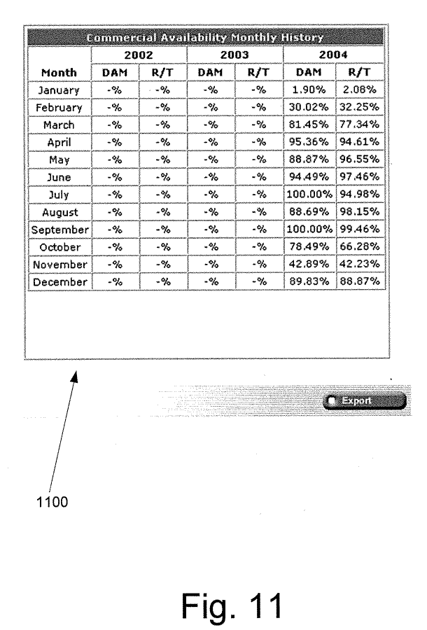

Lost profits may be displayed on a display device in step 910. The display may be in the form of a graphical user interface that may include conventional interface elements, such as links to other pages, menu items and graphical elements. In one embodiment a graphical user interface may include a link that links lost profits to market interaction event trend information. For example, lost profits may be displayed in the form of a hyperlink that links to a display of generation outage trend information or commercial availability history. FIG. 11 illustrates an exemplary graphical user interface 1100 that shows monthly commercial availability history information.

In step 912 it is determined whether a policy contributed to the occurrence of the market interaction event. A policy may require that generation outages occur at specific times and those times may occur during peak demand periods. Computer systems and software applications may be used to search data and identify associations between policies and market interaction events. When a policy did not contribute to the occurrence of the market interaction event, the process ends in step 914. When a policy did contribute to the occurrence of the market interaction event, in step 916 a change in the policy that will decrease the likelihood that the market interaction event will reoccur is identified. Exemplary policy changes include rescheduling generation outages, alerting traders when certain trading opportunities exist and reducing generation during specific time periods.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A computer-implemented method of evaluating decisions associated with energy market interaction events, the method comprising:
(a) identifying a market interaction event that resulted in a lost opportunity;
(d) determining lost revenue associated with the market interaction event;
(c) determining cost savings associated with the market interaction event;
(d) determining lost profits by subtracting the cost savings from the lost revenue; and
(e) displaying the lost profits on a display device.

2. The computer-implemented method of claim 1, wherein the market interaction event comprises an energy generation event.

3. The computer-implemented method of claim 1, wherein the market interaction event comprises a marketing event.

4. The computer-implemented method of claim 1, wherein (e) comprises displaying the lost profits as part of a graphical user interface that includes at least one link that links to additional information.

5. The computer-implemented method of claim 4, wherein the additional information includes market interaction event trend information.

6. The computer-implemented method of claim 5, wherein the additional information includes generation outage trend information.

7. The computer-implemented method of claim 1, further including:
(f) identifying a policy that contributed to the occurrence of the market interaction event.

8. The computer-implemented method of claim 7, wherein the market interaction event comprises a lost opportunity associated with pricing.

9. The computer-implemented method of claim 7, wherein the policy regulates an energy generation operating parameter.

10. The computer-implemented method of claim 7, further including:
(g) identifying a change in the policy that will decrease the likelihood that the market interaction event will reoccur; and
(h) displaying the change in the policy on the display device.

11. The computer-implemented method of claim 1, wherein the market interaction event comprises a generation forced outage event.

12. The computer-implemented method of claim 1, wherein the market interaction event comprises a generation scheduled outage event.

13. The computer-implemented method of claim 1, wherein the market interaction event comprises an unused capacity allocation event.

14. The computer-implemented method of claim 10, wherein the market interaction event comprises a generation allocation event.

15. A tangible computer-readable medium containing computer-executable instructions for performing the steps comprising:
(a) identifying a market interaction event that resulted in a lost opportunity;
(d) determining lost revenue associated with the market interaction event;
(c) determining cost savings associated with the market interaction event;
(d) determining lost profits by subtracting the cost savings from the lost revenue; and
(e) displaying the lost profits on a display device.

16. The tangible computer-readable medium of claim 15, wherein the market interaction event comprises an energy production event.

17. The tangible computer-readable medium of claim 15, wherein the market interaction event comprises a marketing event.

18. The tangible computer-readable medium of claim 15, further including computer-executable instructions for performing the step comprising:
(f) identifying a policy that contributed to the occurrence of the market interaction event.

19. A computer-implemented method comprising:
(a) analyzing market interaction events that are associated with the generation and sale of energy;
(b) identifying market interaction events that resulted in lost opportunities; and
(c) calculating and displaying lost profits associated with the identified market interaction events.

20. The computer-implemented method of claim 19, further including:
(d) identifying at least one policy that contributed to the occurrence of a market interaction event that resulted in a lost opportunity.
